(19) United States
(12) Patent Application Publication
(10) Pub. No.: US 2010/0211912 A1
(43) Pub. Date: Aug. 19, 2010

(54) Interactive Graphical User Interface for an Internet Site Providing Data Related to Radio Frequency Emitters

(75) Inventor: Douglas M. Williams, Del Mar, CA (US)

Correspondence Address: PROCOPIO, CORY, HARGREAVES & SAVITCH LLP, 525 B STREET, SUITE 2200, SAN DIEGO, CA, 92101, US

(73) Assignee: RF CHECK, INC., Del Mar, CA (US)

(21) Appl. No.: 12/535,540

(22) Filed: Aug. 4, 2009

Related U.S. Application Data
(63) Continuation of application No. 11/100,947, filed on Apr. 6, 2005, now abandoned.
Application No. 11/100,947 is a continuation-in-part of application No. 10/215,495, filed on Aug. 8, 2002.

(51) Int. Cl. G06F 3/048; H04B 17/00

(52) U.S. Cl. 715/810; 455/67.7

(57) ABSTRACT

An interactive graphical user interface adapted for receiving user power down requests and for providing data related to RF emitter sites through a plurality of logically interrelated and interactive graphical monitor screens including: a search screen presenting plural location criteria for the sites, and adapted for receiving location requests; an information screen having a plan view MPE map; a wide area aerial map; a photographic camera view; and a list of site facts; a contacts screen presenting information about the RF emitters on a selected site, including an identity a broadcaster, owner, property manager, and municipal entity; and a request screen adapted for accepting, for a selected RF emitter, a power down request.

### RELATED APPLICATIONS

This application claims priority to and is a Continuation of U.S. application Ser. No. 11/100,947 filed Apr. 6, 2005, which is a Continuation-In-Part of U.S. application Ser. No. 10/215,495 filed Aug. 8, 2002 and entitled: Composite Energy Emission Information System For Improved Safety To Site Personnel, both of which are incorporated herein by reference in their entirety.

### BACKGROUND OF THE INVENTION

1. Field of the Invention

This invention relates generally to information systems concerned the public exposure to RF emissions and more particularly to a graphical user interface for interaction with such an information system.

2. Description of Related Art

The following art defines the present state of this field and each of the following U.S. disclosures is hereby incorporated herein by reference:

Douglas et al., U.S. Pub. 2003/0069648, relates to a system and method for tracking, monitoring, and managing equipment. An embodiment of the system for monitoring and managing equipment comprises: one or more mobile pieces of equipment; one or more fixed pieces of equipment; a central: processing system; and one or more means for communicating data between said equipment and said central processing system. The data may be location or status data, but in particular it comprises real-time data concerning the equipment.

Bouix et al., U.S. 5297193, discloses a wireless telephone network that includes a distribution network having fixed stations and wireless digital telephones linked by radio to the fixed stations, an integrated services digital public switching telephone network to which each fixed station is connected by a user to user signaling channel, service control points connected to the public switching telephone network and each having a wireless telephone service subscriber database and a call processing device, and a service management system having a reference database. The network is maintained on a centralized basis by transmitting a maintenance message from a fixed station to a service control point over the user to user signaling channel in response to the fixed station detecting a fault, generating a maintenance ticket at the service control point, transmitting the maintenance ticket to the service control point, and storing the maintenance ticket in the database.

Gulledge, U.S. Pat. No. 5,490,204, discloses an automated system that assesses the quality of service provided by a cellular radiotelephone system. The system uses apparatus located at a mobile station that remotely controls apparatus located at a fixed station. A cellular radiotelephone call is placed from the mobile station which is received at the fixed station. When the connection is established, commands are sent from the mobile station to the fixed station that configure and control the operation of the fixed station. Many calls between the mobile station and the fixed station are placed and received by the mobile station each under control of the mobile station. During each call, recordings are made of the progress of the call and the audio quality measurements obtained during the call from both the mobile and fixed stations perspectives. Audio quality measurements are made utilizing enhanced audio quality measurement techniques that allows simultaneous measurements of audio quality in both the uplink and downlink channels of a cellular radiotelephone call utilizing two test tones instead of the single test tone that is normally used. The results of a number of cellular radiotelephone calls are later combined to form a set of statistical indicators that effectively represent the quality of service provided by a cellular radiotelephone system. The system provides means for comparing the quality of service provided by competing cellular radiotelephone service providers and for comparing the quality of service provided by differing cellular radiotelephone technology types.

Pickering et al., U.S. Pat. No. 5,491,644, discloses a cell engineering tool that evaluates wireless communications channels within and around architectural structures, such as buildings, in order to determine communications transfer characteristics, including the RMS signal power level and the complex-valued frequency-domain transfer function of the communications channel. In architecture, the CET comprises a user interface and an analysis engine that communicates with the user interface. The analysis engine has a plurality of propagation models, which may be run concurrently for validation, if desired. Using the user interface, which is preferably a graphics mechanism, the user inputs a floor plan, wall material parameters (conductivity, permittivity), and the location of a transmitter and receiver within the floor plan. The analysis engine analyzes the input parameters and uses one or more of the propagation models in order to derive a CET output. The propagation models include an analytical model, a ray tracing model, and a statistical model. The analytical model and the ray tracing model are utilized to derive the transfer function and their respective results can be compared with each other for validation. Further, the statistical model may be used to generate a rapid approximation of the RMS signal power loss or level.

Markus, U.S. Pat. No. 5,561,841, discloses a method and a system for planning a cellular radio network. The method includes creation of a model representing the cellular radio network and its radio environment on a digital map. The method further includes adding system properties affecting the traffic control process of the cellular radio network to the model representing the cellular radio network and its radio environment for route specific operational simulation of the cellular radio network. The simulation preferably utilizes subscriber mobility models and immobile and/or mobile individual subscribers generated on the digital map. The simulation events are stored separately for each street, location, network element and/or cause. The optimization of the parameters of the cellular network is performed on the basis of the stored information. Simulation of an operating cellular network on the basis of statistical data obtained from the network allows an adaptive control of the system parameters.

Soliman et al., U.S. Pat. No. 5,710,758, discloses a novel and improved method and apparatus for planning a wireless telecommunications network. An electronic representation of wireless telecommunications system can be configured within a given market area and the operation of that wireless telecommunications system simulated. The simulation is performed using a set of databases that contain terrain and population information associated with the market area over which the wireless network in configured. To perform the simulation a composite propagation loss matrix and a demand and service vector are generated using the terrain and population information, as well as the configuration of the wireless telecommunications network. Once the composite propagation loss matrix and the demand and service vector are generated an analysis of the reverse link is performed. Subsequently, an analysis of the forward link is performed. During both the reverse and forward link analysis the multiple iterations of analysis are performed until a stable result is achieved. Upon completion of the reverse and forward link analysis, the results of the simulation are displayed in a graphical manner for examination.

Almeida et al., U.S. Pat. No. 6,008,808, discloses data manipulation and visualization tools for organizing, managing and navigating through complex data. The tools retrieve and manipulate this data through graphical user interface software executed by a computing device. Using the graphical user interface, a user may browse through multiple simulated layers of complex data, display a plurality of complex data in one or more simulated layers on a single screen, or view historical traffic performance information for a predefined time period.

Remy, U.S. Pat. No. 6,091,950, discloses a system and method to control a cellular radio communications network, in particular according to the GSM standard. The system of control includes fixed means for the recording and time-stamping of signaling information traveling through at least one interface among the various types of interfaces capable of being observed; fixed means for the centralization of the recorded and time-stamped signaling data; means for the association of localization information with said signaling information so as to precisely localize segments of said cellular network located down line from each interface on which signaling information is recorded.

Sattar et al., U.S. Pat. No. 6,154,728, discloses an apparatus, method and system that are provided for automatic and distributed inventory processing for remote communication sites, such as remote cellular sites. A system embodiment includes a central site having a central processor, such as a mobile switching center, and a multitude of remote communication sites, with each remote communication site having a plurality of field replaceable units; and further having a remote processor and a remote memory. The remote processor includes instructions for obtaining an address and status from the memory of each field replaceable unit within the remote communication site and for querying each field replaceable unit having a status not out of service to obtain its vintage information and its physical location information. In the preferred embodiment, the physical location information includes frame, shelf and slot locations, and the vintage information includes hardware and firmware versions. The inventory information may also be compiled into a database, preferably at the central site.

Suutarinen, U.S. Pat. No. 6,219,544, discloses a method of measuring radio path quality values in a digital mobile telephone network comprising at least one mobile station. In the method, coordinates of a measuring point are determined and transmitted to the mobile telephone network. A mobile test device measures the radio path quality values from a downlink transmission path. The mobile telephone network measures the radio path quality values from an uplink transmission path. The mobile test device sends the results from these measurements to the mobile telephone network essentially without delay. The mobile telephone network receives the measurement results sent by the mobile test device and combines them with its own measurement results and with the coordinates of the measuring point essentially without delay. The mobile telephone network has access to the combined measurement results as soon as possible, whereby the measurement results can be used for instance for controlling the location of the test device.

Yost et al., U.S. Pat. No. 6,256,490, discloses a telecommunications system and method that is disclosed for providing a cell traffic supervision alarm within a base station (BS) to notify the operator at a mobile switching center serving the BS that the BS has had no traffic for a period of time that is unreasonably long. The definition of “unreasonably long” is tied to normal traffic patterns at the BS. An alarm threshold time, which is defined as time between the cessation of all traffic on a BS and the triggering of the alarm, can be calculated based upon a statistical analysis of the traffic history of the BS to determine a time interval such that the probability is acceptably small that under normal conditions the BS would have gone for that entire length of time with no traffic at all. At the expiration of the alarm threshold time, the alarm is activated.

Mintz, U.S. Pat. No. 6,266,527, discloses a telecommunications system and method for measuring the bit error rate and power on up-link and down-link channels substantially simultaneously from a mobile terminal to enable real time analysis in the field. This can be accomplished by including an application within a memory in the mobile terminal, which can initiate Link Balance (LB) start and stop commands sent from the mobile terminal to the base station. The LB start command is sent from the MS to the base station, instructing the base station to measure the power and BER on the up-link and forward these measurements to the mobile terminal. Simultaneously, the mobile terminal can measure the power and BER on the down-link and determine the current location. The up-link measurements, down-link measurements, and location information can then be displayed to the technician in real time, either on the mobile terminal itself or on a laptop computer.

Obhan, U.S. Pat. No. 6,275,695, discloses a spectrum yield management (SYM) system that manages an available spectrum within a wireless communication system. The SYM system includes at least one computer and connections within the wireless communication system to other components of the wireless communication system. The SYM system collects real-time and potential loading information for the wireless communication system and receives system operator parameters. The SYM system may support a plurality of classes with each class having subscriber members that receives services commensurate with the class. The SYM system may also support a plurality of corridors within the wireless communication system, with each corridor including at least once cell/sector. The SYM system provides signals to the components of the wireless communication and to subscriber units to influence their operation in a manner that will realize system operator goals with respect to spectrum usage. Examples of such signals include service option signals which provide either an incentive for a subscriber to increase its use or a disincentive for the subscriber to reduce its use. The SYM system may also operate to provide reserved spectrum within the wireless communication system and to perform other functions in managing available spectrum.

Molinari et al., U.S. Pat. No. 6,308,065, discloses an apparatus for testing cellular base stations. A base station tester is connected to a control link between the base station controller and the cellular base station to receive the fixed signal. The fixed link signal contains a voice channel and a control channel that may be selectively monitored by the base station tester. The base station tester is also connected to the radio frequency (RF) output of the cellular base station to receive the RF signal from the cellular base station. Both the RF signal and the fixed link signal are obtained in a non-invasive manner such that the cellular base station may remain in service during the testing process. By monitoring the fixed link directly, the base station tester may evaluate directly the reaction of the cellular base station with its RF signal to the commands received from the fixed link to perform parametric transmitter measurements. The base station tester may further compare the information received from the voice channel with the information contained in the RF signal to perform parametric receiver measurements.

Almeida et al., U.S. Pat. No. 6,356,758, discloses data manipulation and visualization tools for simulating the planning and operation of one or more cellsites within a wireless network, includes an integrated database of cellsite information such as topographical, architectural, and RF propagation data. The tools retrieve and manipulate this data through graphical user interface software executed by a computing device. Using the graphical user interface, a user may simulate the operational characteristics of a cellsite, such as an antenna adjustment at the cellsite, and view cellsite parameters on a computer screen, such as the resulting RF propagation patterns from the antenna adjustment.

Boehmke, U.S. Pat. No. 6,792,269, discloses a system, method and apparatus for tracking deployment of cellular telephone network sites and providing real-time characteristic information about the deployment to one or more users. The system includes a plurality of computers interconnected in a network for use in tracking the deployment of the cellular telephone sites, the plurality of computers each having one or more processors, a memory device for storing one or more sets of instructions to be executed and a storage device coupled to the one or more processors, at least one computer being operative to execute the one or more sets of instructions. The method includes providing a user interface accepting project variables entered into a computer; color coding changes that are made to the variables; in real-time, determining cellular telephone site deployment characteristics based on current project variables; and providing the deployment characteristics to an output device. The apparatus includes a computer for use in tracking the deployment of the cellular telephone sites, the computer having one or more processors that execute one or more sets of instructions, a memory device for storing the one or more sets of instructions to be executed and a storage device coupled to the one or more processors.

Martin et al., U.S. Pat. No. 6,795,707, discloses methods and systems for correlating antenna infrastructure placement information to provide telecommunication quality of service information. In one embodiment, a system includes a database configured to store cellular antenna location information for a plurality of cellular antennas associated with a first service provider, and to store cellular antenna placement information for a plurality of antennas associated with a second service provider. The system further includes a first instruction configured to transmit a request over a network to a first terminal for a user to identify a first location in which the user intends to utilize cellular service, a second instruction configured to request the user to identify a travel route connecting to the first location on which the user uses cellular service, a third instruction configured to determine the cellular coverage provided by the first service provider for areas along the travel route.

Almeida, EP 0928121, discloses data manipulation and visualization tools for simulating the planning and operation of one or more cellsites within a wireless network including an integrated database of cellsite information such a topographical, architectural, and RF propagation data. The tools retrieve and manipulate this data through graphical user interface software executed by a computing device. Using the graphical user interface, a user may simulate the operational characteristics of a cellsite, such as an antenna adjustment at the cellsite, and view cellsite parameters on a computer screen, such as the resulting RF propagation patterns from the antenna adjustment.

Somoza, et al, U.S. Pat. No. 6,336,035, discloses software tools for simulating the planning and operation of one or more cellsites within a wireless network utilizing a database of cellsite information such as GPS, topographical, street map, architectural, RF propagation, and end user data. The tools retrieve and manipulate this data through a graphical user interface executed by a computing device. Using the graphical user interface, a user may simulate product information, drive tests, radio frequency propagation data, and user location profiles within a cell.

Our prior art search with abstracts described above teaches graphical user interfaces (GUI) for enabling a person to input and extract information from a data base, as for instance via the Internet or a local intranet, and particularly such information is known to be concerned with electromagnetic emissions for communication and information transfer in the form of data; and more particularly with radio frequency (RF) communications. For instance, Almeida et al, U.S. Pat. No. 6,008,808, teaches a data manipulation and visualization tool for navigating through complex information or data. Such tools include a GUI software execuated by a computer. In this the user may browse, view and print information of choice. More to the objective of the present information, Martin et al, U.S. Pat. No. 6,795,707, teaches methods and systems for enabling information related to telecommunication antenna infrastructure placement to be accessed in order to provide quality of service to be obtained. However, the prior art fails to teach a GUI enabling a user to locate and display existing cellsites and information related thereto, to display camera views, to create site previews and MPE (Maximum Permissible to Exposure) overlay maps following OET 65 bulletin—Evaluating Compliance With FCC Guidelines for Human Exposure to Radiofrequency Electromagnetic Fields, published by the Federal Communication Commission; and print them, to make power-down requests, to update data, to conduct an area frequency search and to conduct an area site search. The present invention fulfills these needs and provides further related advantages as described in the following summary.

### SUMMARY OF THE INVENTION

The present invention teaches certain benefits in construction and use which give rise to the objectives described below.

The present invention is a software driven Internet or intranet interactive graphical user interface (GUI) enabled for locating existing radio frequency (RF) emission sites particularly those in use as part of the public cell telephone network. However, although this disclosure focuses on the public cell telephone network, the principals of the present invention are applicable to all RF emitters and emitter networks that propagate electromagnetic energy levels that may be harmful to those in close proximity thereto and especially to those where the general public, or field workers, such as repair personnel, lamp changers, painters and the like may come into close contact with emitters. The present invention is enabled for displaying site information from a database, for displaying photo quality camera views, for creating and printing site previews and MPE maps, for providing engineering tools, for sending power down requests, and for providing emission frequency and site searches among other capabilities.

It is presently recognized that the quickly expanding public cell telephone network of RF emitters installed by a growing number of host companies presents a public danger due to RF radiation. Although it is clear that the current frequency ranges and power levels of such emissions, and the physical locations of associated emitters, i.e., transmitting antennae, generally are not presently considered to pose a danger to the public, it is also clear that a danger does exist to field workers and to certain portions of the general public. The present GUI based invention is designed to alleviate and ultimately eliminate such dangers. As a key point, graphic representation of MPE studies, information about RF emissions, frequencies, power levels, special coordinates, etc., from any one antenna is available, if not elsewhere, at least from the corresponding broadcaster, however, since many antennae support towers and similar support elements are used by competing broadcasters, the composite effect of transmission from such locations is not known or knowable except by the accumulation of the individual data from each of the broadcasters in one place and the utilization of standard and well known calculations for the determination of the composite effect, which may be far more dangerous to personnel proximate such locations than the effect from any one broadcaster's emissions. The present disclosure teaches a solution to this dilemma.

The GUI displays data from a database as well as the results of calculations on a user's monitor screen at the user's request. This data is preferably stored in an SQL database and transmitted in XML format and generated on screen using Flash™ programmed software.

In a best mode preferred embodiment of the present invention, an interactive graphical user interface is adapted for receiving power down requests for RF emitter sites and for providing site data through a plurality of logically interrelated and interactive graphical monitor screens including: a search screen presenting plural location criteria for the sites, and adapted for receiving location requests; an information screen having a plan view MPE map; close view horizontal and vertical MPE map; a wide area aerial map; a photographic camera view; and a list of site facts; a contacts screen presenting information about the RF emitters on a selected site, including an identity a broadcaster, owner, property manager, and municipal entity; and a request screen adapted for accepting, for a selected RF emitter, a power down request.

A primary objective of the present invention is to provide an apparatus and method of use of such apparatus that yields advantages not taught by the prior art.

Another objective of the invention is to provide the information necessary to determine the RF emission danger to workers and others in proximity to RF emitters and especially from the composite effects of plural emitters in a common area.

A further objective of the invention is to provide for power down requests from entities wishing to use facilities associated with RF emitters.

A still further objective of the invention is to determine the intermodulation and isolation values between proximate RF emitters.

A still further objective of the invention is to determine a safety level associated with RF emitters.

A still further objective of the invention is to provide a saving in labor by replacing field worker acquisition of information concerning specific RF emitter site proximity with database acquisition including photographic views of such sites.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 is a block diagram of the present invention in a preferred embodiment;

FIGS. 2A-13A are schematic diagrams of computer monitor screens of a graphical user interface thereof; and

FIGS. 2B-13B are facsimiles of the actual graphical user interface computer monitor screens corresponding to the schematic diagrams of FIGS. 2A-13A respectively.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

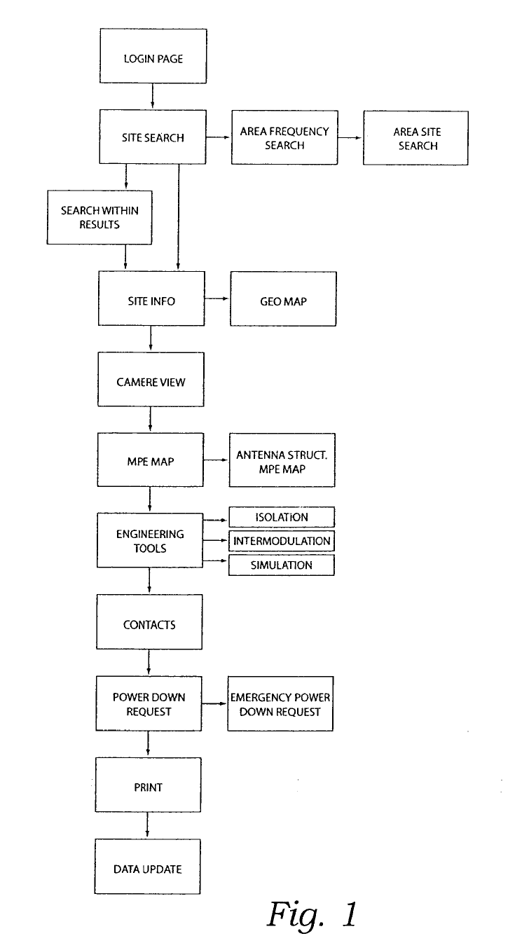

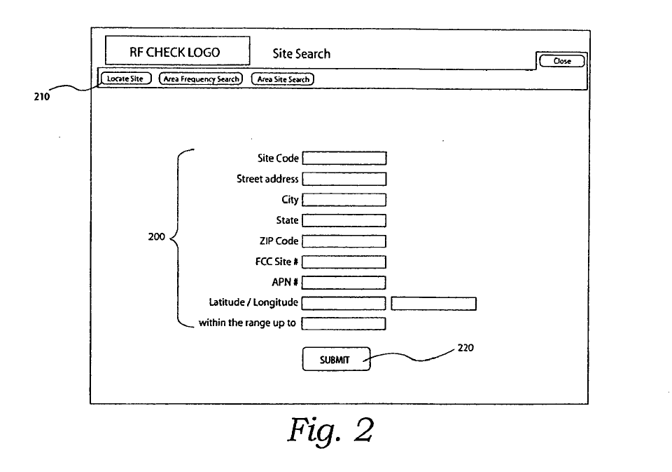

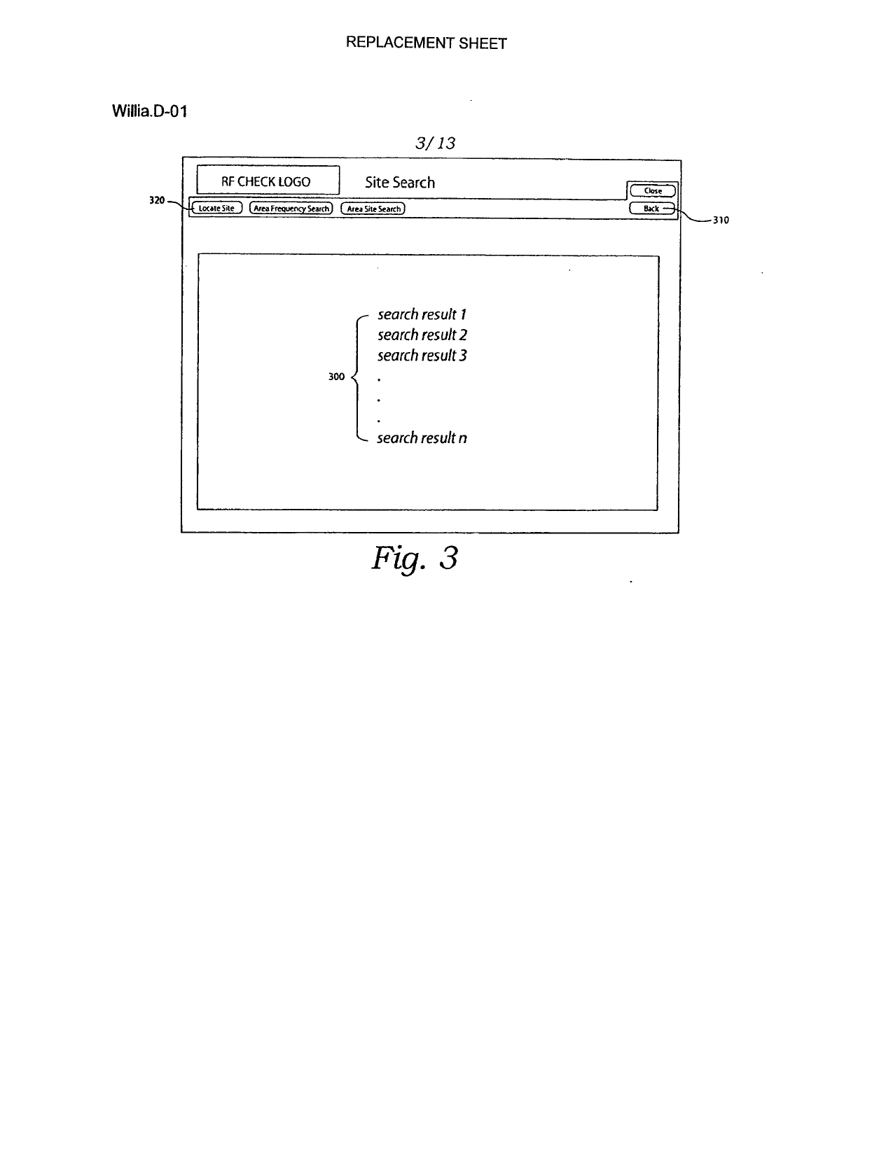

In a preferred embodiment of the present invention, as shown in FIG. 1, a user accesses the software application via the GUI by providing a valid user name and password as is well known in the art. By default the application displays a site search screen. See FIG. 2A, a schematic diagram of the access screen, and FIG. 2B, a picture of the actual screen. From this screen a user input the necessary information to the application to find a particular site using an address, FCC site number, APN number, or even latitude and longitude, and can specify a range of distance from the entered coordinates. Based on the input information from the user the application will one site, multiple sites, or a list of geographic areas for further refinement. See FIGS. 3A and 3B where refinement of site location can take place.

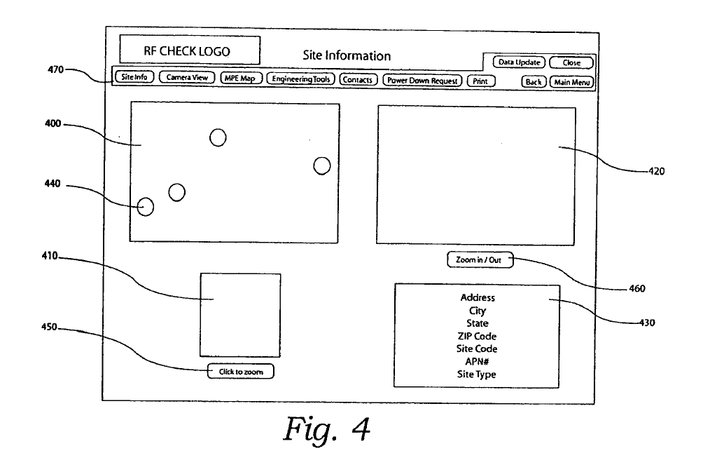

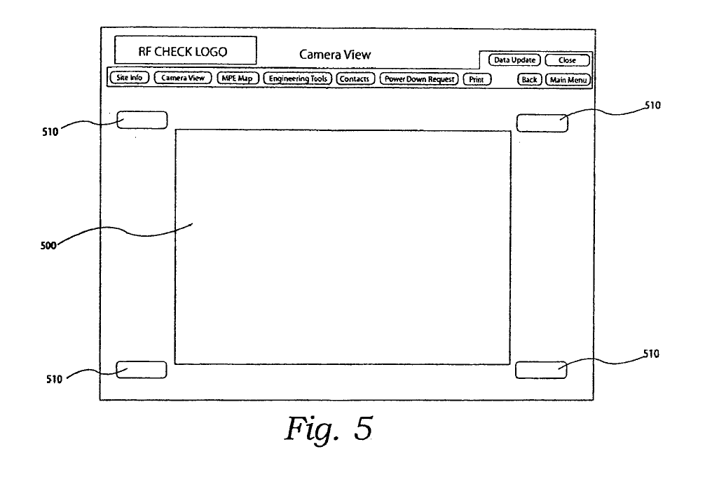

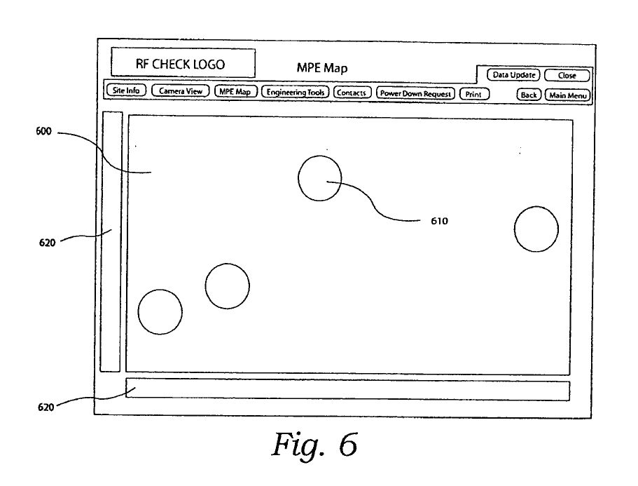

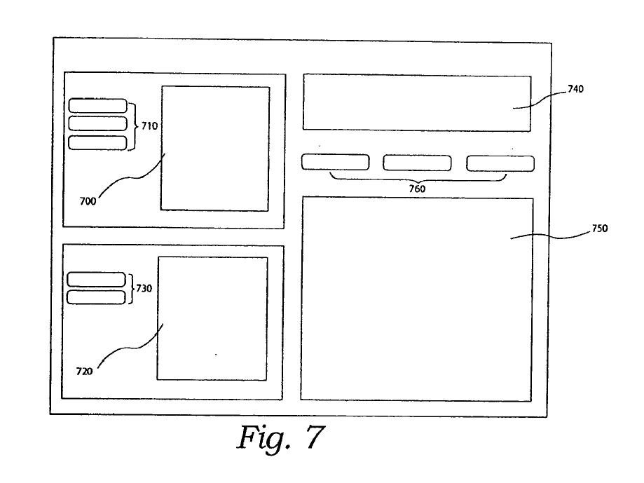

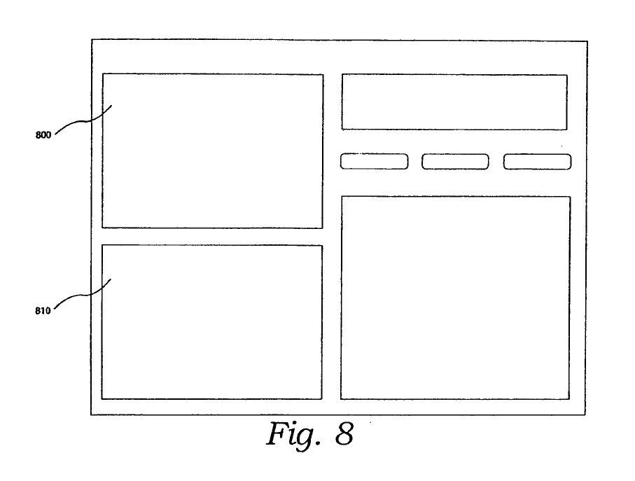

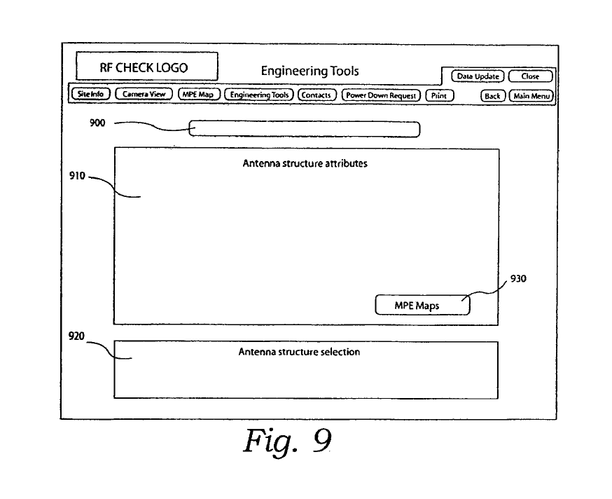

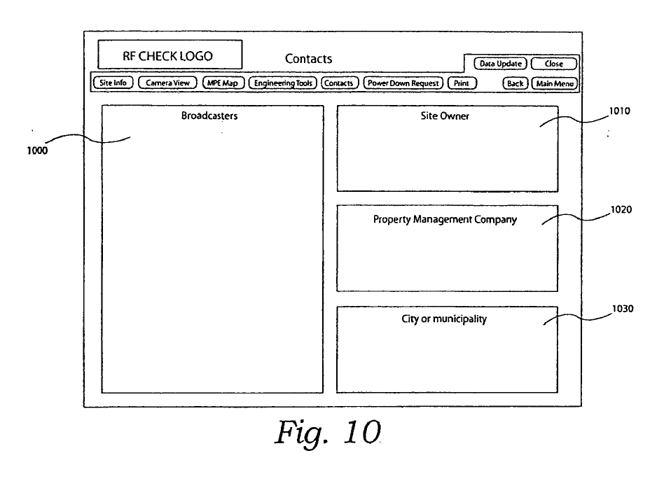

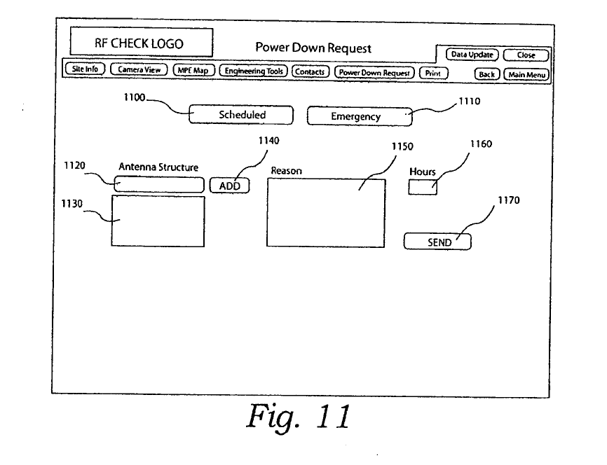

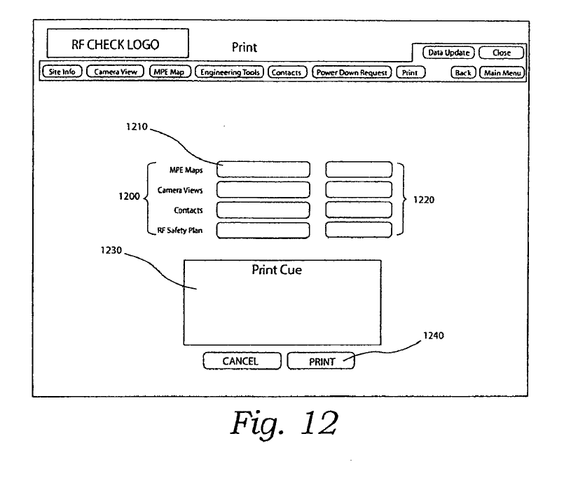

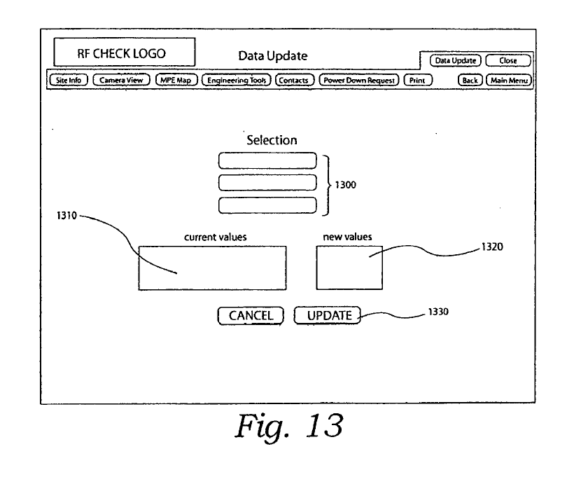

After location of a desired site, the application displays a site information screen by default; see FIGS. 4A and 4B. From this screen a user can access other screens related to the selected site, including a camera view screen depicting the chosen site in a photographic image; FIGS. 5A and 5B; an MPE map screen; FIGS. 6A and 6B; an antenna structure graphics screen; FIGS. 7A, 7B, 8A and 8B; an engineering tools screen; FIGS. 9A and 9B; a contacts screen providing information about site a broadcaster(s), a property management company, a related city or municipality, and a owner; FIGS. 10A and 10B; a power down request screen; FIGS. 11A and 11B; a print utility screen; FIGS. 12A and 12B; and a data update utility screen; FIGS. 13A and 13B.

Referring now to reference numerals in the several figures, it is shown that a user can search sites (220) based on a chosen geographic type. Several search criteria are available (200). and may be used together in a single search request. If a geographic search is conducted and there is more then one site found in the result, the user may select a site from the multiple result (300). For example if a search is conducted on a State, a list of the counties in the State will be displayed. The user can return to a previous search by clicking on a ‘back’ button (310) or he may repeat a search by clicking on a ‘Locate Site’ button (320).

Referring now to FIGS. 2A, 2B, 3A and 3B, search criteria (200) include: Site Code (input field); street address (input field); city (input field, or data grid selection); county (after using State criteria); State (selection box); ZIP code (input field); RF CHECK site code (data grid selection); FCC site # (input field); APN site # (input field); and latitude-longitude coordinates (input field). This screen allows a user to navigate to other screens in the application (210).

Referring now to FIGS. 4A and 4B, after locating a site a site information screen is displayed. This screen contains a site top preview with MPE maps (400), a geographic map preview (410); a site panoramic view or camera view (420) and certain site information (430). The preview (400) is based on data from the database that is used to dynamically create the site top view preview map showing all site elements. (440). The procedure and software for the generation of this type of screen is well known in the art. The geographic map preview (410) is generated using web services or stored images, and displays the site on a geographic map. A zoom button (450) may be used to enhance the map detail. The panoramic View or Site Camera View (420) loads an external site camera view or panoramic image of the site into a custom Flash component allowing panoramic view simulation and zooming (460). Site Information (430) includes address, city, state, zip code, RF CHECK site code, APN number and site type. From this screen the user can navigate to other screens using navigation procedures (470).

Referring now to FIGS. 5A and 5B, the camera views are enabled by selecting TL (top left view), TR (top right view), LL (lower left view). LR (lower right view). The user may switch views as desired.

The application calculates and displays a site plan view preview map (600) showing all site elements (610) with dimensions (620) as shown in FIGS. 6A and 6B. Selection of one of the elements (610) produces the screen shown in FIGS. 7A and 7B, a horizontal view (700) with dimension grid and with buttons for switching between RF emitter sectors (710); and a vertical view (720) with dimension grid and with buttons for switching between RF emitter arrays. FIGS. 7A and 7B provide information about the antenna structure label with its type (740), latitude-longitude (740) location, list of the RF emitter arrays with labels and elevations (750), list of the sectors for all RF emitter arrays with labels and azimuths (740), and list of all antennae for one sector with labels, frequencies, power output levels, antenna types, and models (740). Also, as shown in FIGS. 8A and 8B, one may navigate to the camera views to better understand the emitter (antenna) physical structure and its surroundings.

Navigation to the screen shown in FIGS. 9A and 9B, we can select (900) any antenna on the site to view all information about that antenna (910). The user can manipulate the data and then view MPE maps reflecting these changes (930). The user can calculate intermodulation and isolation between any two selected antennas. (920) ‘What-if’ analyses may be conducted using existing data to view MPE maps including intermodulation and isolation calculations based on user changes of the parameters (910).

Navigation to the contact information screen shown in FIGS. 10A and 10B enables the user to obtain the identify of site broadcasters (1000), site owners (1010), a property management company (1020), and a related city or municipality (1030). Each of these contact points provides company name, contact person name, contact person title, phone, fax, cell phone, e-mail address, physical address, city, zip, and state. Such information is invaluable to those interested in making a change to existing emitter structure or use.

An important objective of the present invention is to enable the information transfer necessary to provide for a power-down situation, as shown in FIGS. 11A and 11B. If, for example, one wishes to perform maintenance on a tower supporting an RF emitter, the safety of workers needs to be provided for. The application allows the user to send a request to power down an RF single emitter or multiple emitters, a tower or a group of towers, etc. (1120,1130,1140). The request provides a reason (1150) and a requested power down duration (1160). Such a request is made by e-mail to a broadcaster using a particular antennas structure with a copy of that e-mail to site owner, property management company and city of municipality associated with the site where the particular antenna structure is mounted. A database entry is made and a confirmation is returned to the requestor. In an emergency, the power down screen allows a user to see emergency request instructions, phone numbers and e-mail addresses of broadcasters for selected antenna structures to contact them directly.

The print screen shown in FIGS. 12A and 12B provide for the user to print (1240) database outputs based on selections (1200) from site antenna structures (1210). The user can add (1220) selected pages to a print cue (1230). The user can print: an MPE map for a specific antenna structure or for an entire site, camera views, contact information and site safety plans. Each authorized broadcaster is enabled, using a secret PIN code, for editing data within the database of the GUI concerning those RF emitters that he has legal jurisdiction over for broadcasting. Each data update is recorded in the database, including the name of the user making the update, the date of the update, updated data, and old and new values.

In summary, it is clear from the above, that the present GUI application software, may be prepared, formatted, debugged and placed into operating order by those of skill in the art with no further understanding than as described herein. However, the format and operation of the present GUI is novel in light of all known prior art. Further, the present invention could not be considered an obvious modification of any one prior reference nor an obvious combination of any combination of prior references. This is because the objective of the present invention is novel in itself as well as distinct with respect to the prior art, causing the means to its satisfactory accomplishment to be also novel and distinct with respect to the prior art.

For example, the prior art discloses data manipulation and visualization tools for simulating the planning and operation of one or more cellsites within a wireless network including an integrated database of cellsite information such as topographical, architectural, and RF propagation data. The prior art also teaches the tools necessary to retrieve and manipulate this data through a graphical user interface software executed by a computing device. Using the graphical user interface, a user may simulate the operational characteristics of a cellsite, such as an antenna adjustment at the cellsite, and allow the viewing of cellsite parameters on a computer screen, such as a resulting RF propagation pattern from the antenna adjustment. However, the prior art is silent as to a GUI enablement for requesting a cellsite downtime for maintenance or other needs. Also, the prior art is silent as to the composite effect of closely configured RF emitters (intermodulation effect). This is critical as no system has been presented in this industry nor any practical suggestion proffered to accomplish this important end effect. Also, the prior art is silent as to the creation of MPE studies important for public safety and is unfortunately adapted to provide wide-area coverage maps of propagation rather then propagation models near the RF emitters. It is only through this enablement of composite information from all cellsite emitters at a particular site that one can gain the competence to avoid dangerous exposure of workers to the effects of such emitters. Whereas, the prior art teaches the storage of information about individual sites, the present GUI enables the retrieval of information concerning all emitters at any given site including the cumulative RF effects of the emitters of competing cellular broadcasters.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An interactive graphical user interface for receiving power down requests for RF emitter sites and for providing data related to such sites comprising: a plurality of logically interrelated and interactive graphical monitor screens including;
(a) a search screen presenting location criteria for RF emitter sites, the search screen adapted for receiving location requests and employing corresponding stored data therefore including cumulative effects of competing RF broadcasters;
(b) an information screen comprising, for a selected one of the sites, at least one of elements: a plan view MPE map; an wide area aerial map; a camera view; and a list of facts; the elements including information for all RF emitters at the selected one of the sites;
(c) a contacts screen presenting information about the RF emitters on the selected site, including an identity of at least one of the selected site related: broadcaster, owner, property manager, and municipal entity; and
(d) a request screen adapted for accepting an identity of an RF emitter, a power down request reason, and a request duration.

2. The interactive graphical user interface of claim 1 further comprising: a tools screen adapted for calculating actual and hypothetical values of intermodulation and isolation between RF emitters selected through the user interface by a user.

3. The interactive graphical user interface of claim 1 wherein the plan view MPE map is adapted for user selection of at least one point of view.

4. The interactive graphical user interface of claim 1 further comprising an RF emitter structure map presenting plan and elevational views of a selected RF emitter.

5. The interactive graphical user interface of claim 4 wherein the RF emitter structure map further presents emission data for the selected RF emitter.

6. The interactive graphical user interface of claim 5 wherein the emission data includes at least one of a location identity; a statement of RF emitter sector azimuth and RF emitter array elevation; and for occupied sectors an identification of sector size, emission frequency of RF emitters installed on sector, power output and type of RF emitters.

7. An interactive graphical user interface method for RF emitter sites power down requests through the presentation of a plurality of logically interrelated and interactive graphical monitor screens, the method comprising the steps of;
(a) presenting plural location criteria for the sites; receiving location requests from the user; employing a database of information concerning all RF emitters at selected sites including the cumulative effects of RF emissions from all competing RF broadcasters at each of the sites;
(b) presenting on screen, for a user selected one of the sites, at least one of elements: a plan view MPE map; an wide area aerial map; a camera view; and a list of facts;
(c) presenting on screen, information about the RF emitters on the selected site, including an identity of at least one of the selected site related: broadcaster, owner, property manager, and municipal entity; and
(d) presenting a screen adapted for accepting an identity of an RF emitter, a power down request reason, and a request duration.

8. The interactive graphical user interface method of claim 7 further comprising the step of presenting a tools screen adapted for calculating actual and hypothetical values of intermodulation and isolation between the RF emitters selected through the user interface by a user.

9. The interactive graphical user interface method of claim 7 further comprising the step of adapting the plan view MPE map for user selection of at least one point of view.

10. The interactive graphical user interface method of claim 7 further comprising the step of adapting an RF emitter structure map for user selection of plan and elevational views of a selected RF emitter.

11. The interactive graphical user interface of claim 10 further comprising the step of adapting the RF emitter structure map for user selection of emission data for a selected RF emitter.

12. The interactive graphical user interface of claim 10 further comprising the step of presenting the emission data with at least one of a location identity; a statement of sector azimuth; and for occupied sectors an identification of sector size, emission frequency, power output and type of sector.
